(19) United States
(12) Patent Application Publication
(10) Pub. No.: US 2002/0196886 A1
(43) Pub. Date: Dec. 26, 2002

(54) SYNC pulse compensation and regeneration in a clock synchronizer controller

(76) Inventor: Richard W. Adkisson, Dallas, TX (US)

Correspondence Address: HEWLETT-PACKARD COMPANY, Intellectual Property Administration, P.O. Box 272400, Fort Collins, CO, 80527-2400, US

(21) Appl. No.: 09/887,797

(22) Filed: Jun. 22, 2001

(51) Int. Cl. H04L 7/04

(52) U.S. Cl. 375/362

(57) ABSTRACT

A SYNC pulse compensation and regeneration apparatus and method for use with a high skew tolerant, low latency clock synchronizer controller utilized for synchronizing data transfer operations between two circuit portions across a clock domain boundary. A primary clock signal is operable to clock a first circuit portion and a secondary clock signal, generated from the primary clock signal, is operable to clock a second circuit portion. A SYNC pulse signal is generated based on coincident rising edges of the primary and secondary clock signals. A sampling compensation circuit is operable to condition the SYNC pulse signal by inserting a logic high pulse when the SYNC pulse is lost, or by removing duplicate SYNC pulses when necessary. A jitter cycle delay compensation circuit coupled to the sampling compensation circuit is operable to stage the SYNC pulse through a series of delay registers to compensate for clock skew when the SYNC pulse jumps ahead or behind a clock cycle.

### CROSS-REFERENCE TO RELATED APPLICATION(S)

This application discloses subject matter related to the subject matter disclosed in the following commonly owned copending patent application(s): (i) “System And Method For Synchronizing Data Transfer Across A Clock Domain Boundary,” filed ______, Ser. No.: ______ (Docket Number 10010788-1), in the name(s) of: Richard W. Adkisson, which is(are) hereby incorporated by reference for all purposes.

### BACKGROUND OF THE INVENTION

1. Technical Field of the Invention

The present invention generally relates to clock synchronization techniques. More particularly, and not by way of any limitation, the present invention is directed to a SYNC pulse compensation and regeneration scheme used in a high skew tolerant, low latency clock synchronizer controller operable to synchronize data transfer operations across a clock domain boundary separating two clock domains.

2. Description of Related Art

Computer systems often need to communicate with different interfaces, each running at an optimized speed for increased performance. Typically, multiple clock signals having different frequencies are utilized for providing appropriate timing to the interfaces. Further, the frequencies of such clock signals are generally related to one another in a predetermined manner. For example, a core or system clock running at a particular frequency (F_{C}) may be utilized as a master clock in a typical computer system for providing a time base with respect to a specific portion of its digital circuitry. Other portions of the computer system's digital circuitry (such as a bus segment and the logic circuitry disposed thereon) may be clocked using timing signals derived from the master clock wherein the derived frequencies (F_{D}) follow the relationship: F_{C}/F_{D}≧1.

Because of the asynchronous—although related—nature of the constituent digital circuit portions, synchronizer circuitry is often used in computer systems to synchronize data transfer operations across a clock domain boundary so as to avoid timing-related data errors. Such synchronizer circuitry is typically required to possess low latency (which necessitates precise control of the asynchronous clocks that respectively clock the circuit portions in two different clock domains). In addition, since phase-locked loops (PLLs) utilized in conventional arrangements to produce clocks of different yet related frequencies can have a large amount of input/output (I/O) jitter, it is essential that the synchronizer circuitry be able to tolerate significant amounts of low frequency phase difference (or, skew) between the clocks caused thereby. Moreover, where a synchronization (SYNC) pulse is used for controlling the synchronizer circuitry, it is critical that the SYNC pulse be capable of regeneration when it is lost, and of jitter compensation when it skips ahead or behind a clock cycle.

### SUMMARY OF THE INVENTION

Accordingly, the present invention advantageously provides a SYNC pulse compensation and regeneration apparatus and method for use with a high skew tolerant, low latency clock synchronizer controller utilized for synchronizing data transfer operations between two circuit portions across a clock domain boundary. A primary clock signal is operable to clock a first circuit portion and a secondary clock signal, generated from the primary clock signal, is operable to clock a second circuit portion. A SYNC pulse signal is generated based on coincident rising edges of the primary and secondary clock signals. A sampling compensation circuit is operable to condition the SYNC pulse signal by inserting a logic high pulse when the SYNC pulse is lost, or by removing duplicate SYNC pulses when necessary. A jitter cycle delay compensation circuit coupled to the sampling compensation circuit is operable to stage the SYNC pulse through a series of delay registers to compensate for clock skew when the SYNC pulse jumps ahead or behind a clock cycle.

In one exemplary embodiment of the present invention, the sampling compensation circuit comprises a plurality of multiplexers (MUXs) (e.g., three) arranged in series. Each MUX is operable to receive a binary input and sampled SYNC pulse input via a timing register. The MUX arrangement is operable to insert a logic high condition in the SYNC pulse signal when it is sampled to contain a plurality of logic lows (i.e., a “000” sequence) during a predetermined time window signifying a lost SYNC pulse. The MUX arrangement is also operable to mask a duplicate logic high condition in the SYNC pulse signal. The jitter cycle delay compensation circuit is preferably provided as a series of delay registers, each of which is operable to delay the SYNC pulse signal by a predetermined amount of time. A MUX is coupled to the delay registers to select a particular delayed SYNC pulse output from the registers based on a JITTER-STATE control signal generated in response to the detected phase difference between the first and second clock signals.

### BRIEF DESCRIPTION OF THE DRAWINGS

A more complete understanding of the present invention may be had by reference to the following Detailed Description when taken in conjunction with the accompanying drawings wherein:

FIG. 1 depicts a functional block diagram of a presently preferred exemplary embodiment of a system for synchronizing data transfer operations between two circuit portions across a clock domain boundary in accordance with the teachings of the present invention;

FIG. 2 depicts a timing sequence of an exemplary SYNC pulse signal based on a pair of clock signals (CLK1 (primary) and CLK2 (secondary) signals) having a 5:4 frequency ratio in an exemplary embodiment of the present invention;

FIG. 3 depicts a functional block diagram of a presently preferred exemplary embodiment of a high skew tolerant, low latency clock synchronizer controller circuit of the present invention for controlling data transfer synchronizer circuitry disposed between two circuit portions;

FIG. 4 depicts an exemplary clock state diagram which includes a plurality of states indicative of different amounts of phase difference between the exemplary primary and secondary clock signals having a 5:4 frequency ratio;

FIG. 5A depicts a timing diagram of the various signals used in the present invention, wherein the exemplary primary and secondary clock signals are in a normal state;

FIG. 5B depicts a timing diagram of the various signals used in the present invention as shown in FIG. 5A, wherein the primary clock signal leads the secondary clock signal;

FIG. 5C depicts a timing diagram of the various signals used in the present invention as shown in FIG. 5A, wherein the secondary clock signal leads the primary clock signal;

FIG. 6A depicts an exemplary data transfer synchronizer circuit for facilitating data transmission from the circuit portion clocked with the primary clock signal to the circuit portion clocked with the secondary clock signal;

FIG. 6B depicts an exemplary data transfer synchronizer circuit for facilitating data transmission from the circuit portion clocked with the secondary clock signal to the circuit portion clocked with the primary clock signal;

FIG. 7 is a flow chart of the various steps involved in an exemplary methodology for synchronizing data transfer operations in accordance with the teachings of the present invention; and

FIG. 8, comprising FIGS. 8A and 8B, depicts a further exemplary embodiment of the clock synchronizer controller circuit of the present invention, wherein SYNC pulse regeneration and compensation is advantageously provided.

### DETAILED DESCRIPTION OF THE DRAWINGS

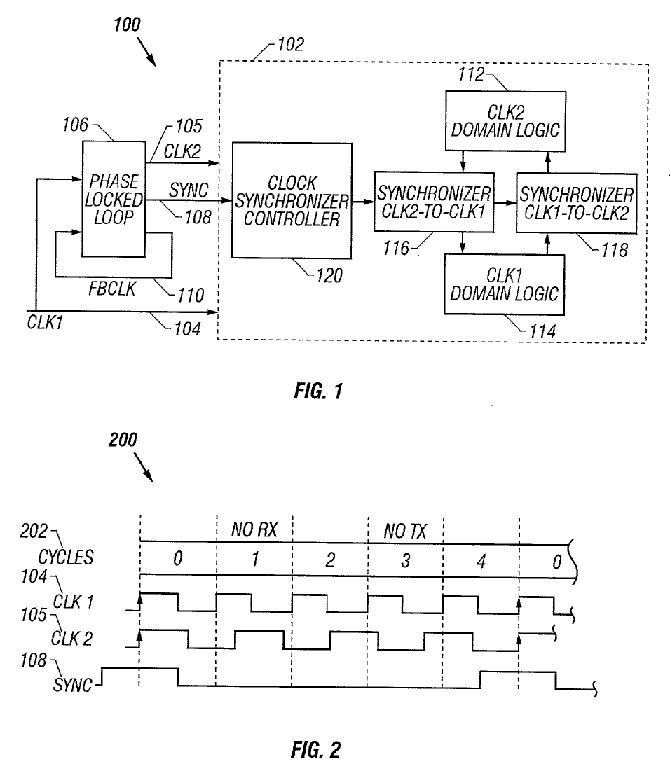

In the drawings, like or similar elements are designated with identical reference numerals throughout the several views thereof, and the various elements depicted are not necessarily drawn to scale. Referring now to FIG. 1, depicted therein is a functional block diagram of a presently preferred exemplary embodiment of a system 100 for synchronizing data transfer operations between two circuit portions across a clock domain boundary in accordance with the teachings of the present invention. Reference numeral 102 refers to a portion of the system 100 wherein a first circuit portion 114 that is clocked with a first (or, primary) clock (CLK1) signal 104 and a second circuit portion 112 that is clocked with a second (or, secondary) clock (CLK2) signal 105 derived from the primary CLK1 signal 104 are disposed. In an exemplary implementation, CLK1 104 is representative of a system clock (also referred to as a core clock) of a computer system and CLK2 105 is representative of a bus clock (i.e., an interface clock) that is generated based on CLK1 for operating a particular bus portion of the computer system at a predetermined frequency. Analogously, CLK1 domain logic and CLK2 domain logic are exemplary of the first and second circuit portions, 114 and 112, respectively, of the computer system wherein data is transferred therebetween.

A phase-locked loop (PLL) 106 is preferably utilized for generating CLK2 105 from CLK1 104. A feedback clock (FBCLK) signal 110 is produced by PLL 106 that is fed back for developing an error signal used in locking the input CLK1 signal 104 with the FBCLK signal 110. Generally, the frequencies of CLK1 and CLK2 are disposed such that the frequency of CLK2 is lower than or equal to the frequency of CLK1. Moreover, in the presently preferred exemplary embodiment of the present invention, the frequency ratio between CLK1 and CLK2 signals is optimized at N: (N−1). That is, for every N cycles of CLK1, there can be (N−1) CLK2 cycles.

Continuing to refer to FIG. 1, a SYNC pulse signal 108 is also preferably generated by PLL 106 based on a predetermined temporal relationship between CLK2 and CLK1 (or, FBCLK signal, more particularly). In the exemplary embodiment, the SYNC pulse is generated when a rising edge of the CLK1 signal coincides with a rising edge of the CLK2 signal. As will be described in greater detail hereinbelow, the SYNC pulse signal 108 is advantageously used by a clock synchronizer controller 120 in accordance with the teachings of the present invention for controlling data transfer synchronizer circuitry (comprised of CLK2-TO-CLK1 synchronizer 116 and CLK1-TO-CLK2 synchronizer 118) disposed between CLK1 and CLK2 domain circuit portions.

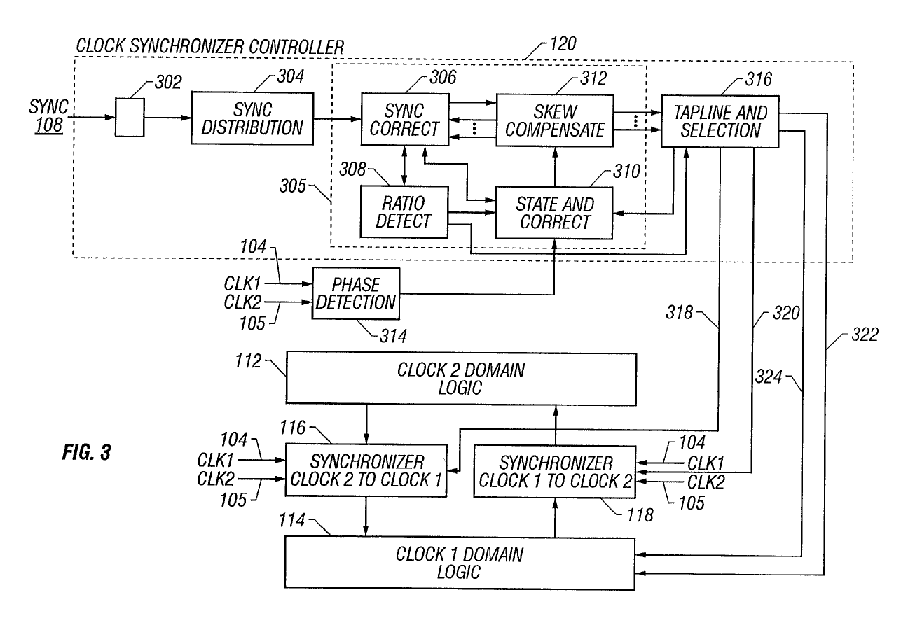

FIG. 2 depicts an exemplary timing sequence 200 of SYNC pulse signal 108 and the primary and secondary clock signals having a 5:4 frequency ratio in an exemplary embodiment of the present invention. A cycle count 202 determines the number of CLK1 cycles into the timing sequence 200. Those skilled in the art should recognize that although the waveform of CLK1 104 is illustrated in this FIG., it is the FBCLK signal (which is essentially a replica of CLK1) that may be used in an exemplary implementation.

As alluded to hereinabove, the SYNC pulse 108 is high on coincident edges of CLK1 and CLK2. In a normal condition where there is no skew (or, jitter, as it is sometimes referred to) between CLK1 and CLK2, the coincident edges occur on the rising edges of the first cycle (cycle 0) as shown in FIG. 2. Data transfer operations across the clock boundary between the asynchronous domains are timed with reference to the SYNC pulse. Since there are 5 CLK1 cycles and 4 CLK2 cycles, CLK1 domain circuit portion cannot transmit data during one cycle, as CLK2 domain circuit portion does not have a corresponding time window for receiving it. Typically, the cycle that is least skew tolerant is the one where data is not transmitted and, in the exemplary timing sequence shown in FIG. 2, it is the fourth cycle (i.e., cycle 3). Similarly, because of an extra cycle (where the data is indeterminate and/or invalid), CLK1 domain circuit portion must not receive data during one cycle. Again, it is the cycle with the least skew tolerance (for example, cycle 1) during which data is not received by the first circuit portion.

Skew between CLK1 and CLK2 signals will cause, for example, a variance in the positioning of the SYNC pulse which affects the data transfer operations between CLK1 and CLK2 domains. In the exemplary 5:4 frequency ratio scenario set forth above, if CLK2 leads CLK1 by a quarter cycle for instance, then instead of the edges being coincident at the start of cycle 0, they will be coincident at the start of cycle 1. In similar fashion, if CLK2 lags CLK1 by a quarter cycle, the edges will be coincident at the start of the last cycle (i.e., cycle 4).

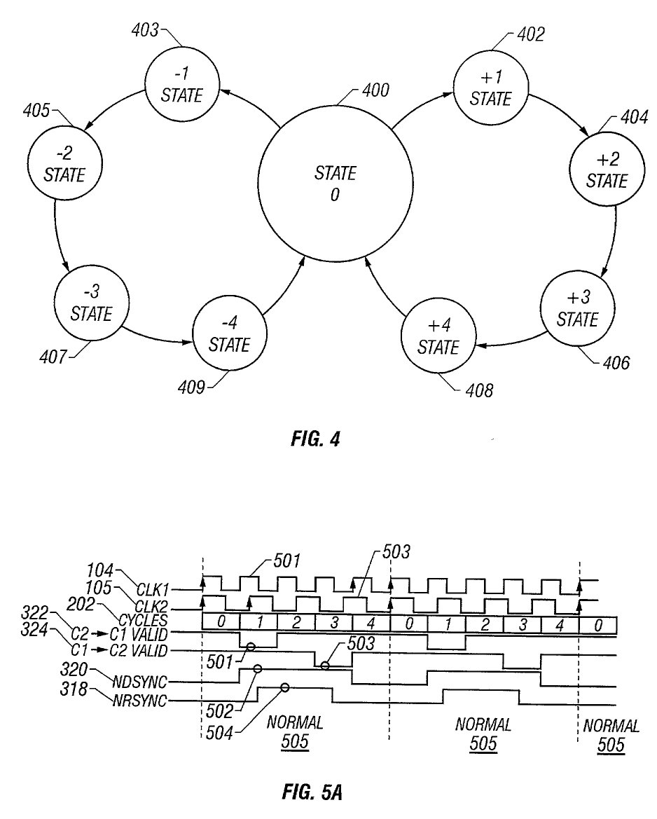

FIG. 3 depicts a functional block diagram of a presently preferred exemplary embodiment of a high skew tolerant, low latency clock synchronizer controller circuit 120 that advantageously compensates for the CLK1/CLK2 skew in generating a plurality of control signals used for actuating the data transfer synchronizer circuitry disposed between the first and second circuit portions. Essentially, the clock synchronizer controller circuit 120 operates by detecting the leading and lagging of clock signals via a phase detector 314, and then adjusts the positioning of the SYNC pulse signal 108 based on the skew of the clocks using a SYNC adjuster 305, whereby cycle 0 follows the new coincident edges of the clocks.

The circuitry of the clock synchronizer controller 120 itself is clocked with CLK1 and thus belongs to CLK1 domain. Since the SYNC pulse signal 108 can be skewed with respect to CLK1, it is preferably “double-registered” or “double-sampled” by means of a flip-flop block 302 before being provided to a SYNC distributor 304 in order to prevent metastability. Preferably, one or more registers form the SYNC distributor block 304. Thereafter, the SYNC pulse signal is provided to a SYNC Correct block 306 which is operable to detect if the SYNC pulse jumped ahead or behind a predetermined clock period, e.g., one CLK1 period. Also, as the SYNC pulse may be lost or doubled due to sampling and skew, a SYNC sampling compensator (which will be described in greater detail hereinbelow) may be provided in a further exemplary embodiment of the present invention.

A Ratio Detect block 308 coupled to the SYNC Correct block 306 is operable to detect a range of frequency ratio relationships between the CLK1 and CLK2 signals so that the frequency of CLK2 can be optimized for different applications. If the number of times the SYNC pulse is sampled low between two successive high pulses using the CLK1 signal is X, the frequency ratio between CLK1 and CLK2 (which is N: (N−1)) is given as (X+1):X. As an illustration, consider the exemplary timing sequence depicted in FIG. 2. The SYNC pulse goes high in cycle 0, commencing the counting. When the SYNC pulse is sampled in cycles 1 through 4, it is low for 4 sampling instances, before it goes high in cycle 0 again. Thus, the frequency ratio of CLK1 and CLK2 signals is 5:4.

Continuing to refer to FIG. 3, a State/Correct block 310 coupled to the phase detector 314 is operable to determine a phase state of the CLK1 and CLK2 signals which is indicative of the phase difference therebetween. Appropriate input (i.e., frequency ratio relationship information) is also provided by the Ratio Detect block 308 to the State/Correct block 310 for this purpose. A Skew Compensate block 312 is operable responsive to the determined state so as to re-position the SYNC pulse. In the exemplary 5:4 frequency ratio scenario, if CLK2 leads CLK1 by a quarter of CLK1, then cycle 1 is where the new coincident rising edges occur. Therefore, in order to set cycle 1 as new cycle 0 (i.e., start of the SYNC pulse cycle), the clock synchronizer controller 120 inserts an extra cycle (e.g., cycle 2 in the case of the 5:4 frequency ratio), whereby the CLK1 and CLK2 are expanded by one CLK1 cycle. This state of the clock signals is considered as [+1 State]. Similarly, if CLK2 leads CLK1 by another quarter clock, then the original cycle 2 is where the new coincident rising edges of the clock signals occur. Consequently, another extra cycle is added to the CLK1 and CLK2 cycles such that cycle 2 now becomes the new cycle 0. This state is considered as [+2 State]. To continue with the remaining states where CLK2 leads CLK1, [+3 State] (original cycle 3 becomes new cycle 0) and [+4 State] (original cycle 4 becomes new cycle 0) can be established based on the increasing skew (or, phase difference) between CLK1 and CLK2. Further, because of the periodicity of the clock signals, the positive skew states loop back to [State 0], before traversing the states again.

Analogous to the positive skew states, the clock synchronizer controller 120 is operable to compensate for the negative skew between the clock signals wherein CLK1 leads CLK2 by a phase difference. Thus, if CLK2 lags CLK1 by a quarter of CLK1, then cycle 4 is where the new coincident rising edges occur. Therefore, in order to set cycle 4 as new cycle 0 (i.e., start of the SYNC pulse cycle), the clock synchronizer controller 120 deletes an extra cycle (e.g., cycle 2 in the case of the 5:4 frequency ratio), whereby the CLK1 and CLK2 are compressed by one CLK1 cycle. This state of the clock signals is considered as [−1 State]. In similar fashion, states [−1] through [−4] are also obtained.

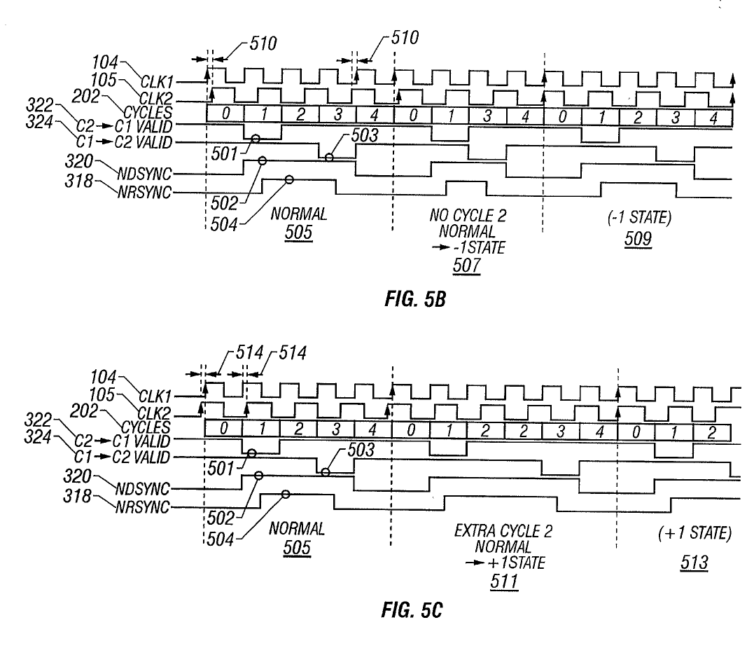

FIG. 4 depicts an exemplary clock state diagram including the states indicative of different amounts of phase difference between the exemplary primary and secondary clock signals having a 5:4 frequency ratio. Where there is no phase difference (i.e., normal condition), the clocks are in State 0 (reference numeral 400). Reference numerals 402, 404, 406, and 408 refer to the four positive clock states and reference numerals 403, 405, 407, and 408 refer to the four negative clock states described hereinabove. It should be appreciated by those skilled in the art that since a full cycle period of skew is identical to the original clock state, the SYNC adjuster 305 of the clock synchronizer controller 120 can theoretically compensate for an infinite amount of skew between CLK1 and CLK2. Moreover, it should be apparent to those skilled in the art that [−1 State] is identical to [+4 State], [−2 State] is identical to [+3 State], [−3 State] is identical to [+2 State], and [−4 State] is identical to [+1 State].

Continuing to refer to FIG. 3 again, a Tapline and Selection block 316 is operably coupled to the Skew Compensate block 312, State and Correct block 310, and Ratio Detect block 308. Responsive to the skew-compensated SYNC pulse signal and appropriate frequency ratio information, the Tapline and Selection block 316 drives a plurality of control signals at appropriate times, wherein at least a portion of the signals are utilized for actuating the data transfer synchronizer circuitry disposed between CLK1 domain circuit portion 112 and CLK1 domain circuit portion 114. Because CLK1 domain circuit portion 114 is provided as a master circuit that initiates the data transfer operations, at least another portion of the control signals are provided thereto for specifying when the transfer operations are valid.

Reference numeral 318 refers to a control signal, labeled as NRSYNC, that is provided to the CLK2-TO-CLK1 synchronizer circuit 116 for controlling data receive operations (RX operations) wherein data is transferred from CLK2 domain circuitry to CLK1 domain circuitry. Similarly, reference numeral 320 refers to NDSYNC control signal that is provided to the CLK1-TO-CLK2 synchronizer circuit 118 for controlling data transmit operations (TX operations) wherein data is transferred from CLK1 domain circuitry to CLK2 domain circuitry. A CLK2-TO-CLK1_VALID signal 322 and a CLK1-TO-CLK2_VALID signal 324 are provided to the CLK1 domain circuitry to appropriately clock the data transfer operations.

In one exemplary embodiment, the Tapline and Selection block 316 may be implemented as a string of delay registers coupled to a control logic block for achieving proper timing relationships with respect to the control signals driven thereby. Further, it should be recognized by those skilled in the art that the various control signals described herein may be staged through flip-flops, clocked registers, and the like before being provided to their respective destinations.

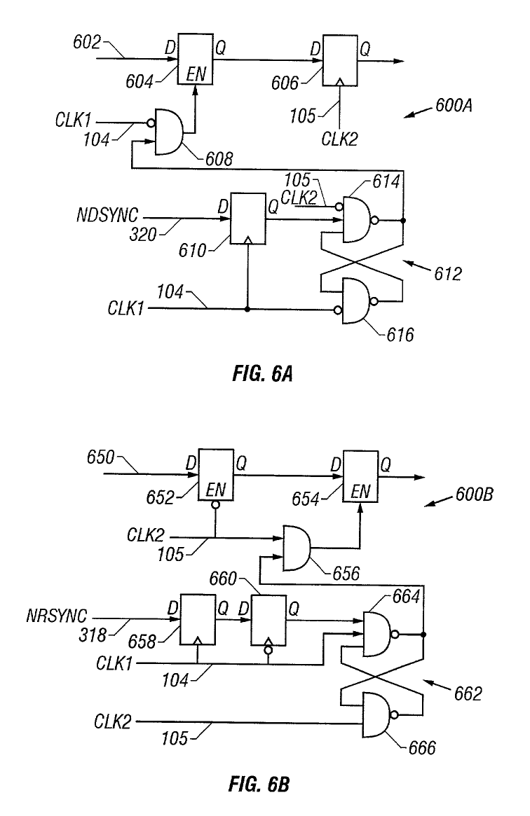

FIG. 5A depicts a timing diagram of the various signals used in the present invention, wherein the exemplary primary and secondary clock signals have no skew therebetween. Accordingly, reference numeral 505 refers to a normal clock state (i.e., [State 0]) with respect to the primary and secondary clock signals. The CLK2-TO-CLK1_VALID signal 322, which is preferably provided as an active high signal, is driven low in cycle 1 to indicate an invalid data receive operation and thus disable it. Reference numeral 501 refers to the logic low level in the CLK2-TO-CLK1_VALID signal 322. The CLK1-TO-CLK2_VALID signal 324 is also preferably provided as an active high signal and thus have a logic low 503 in cycle 3 to indicate an invalid data transmit operation. The synchronizer control signals, NDSYNC 320 and NRSYNC 318, have logic high pulses of appropriate width (reference numerals 502 and 504, respectively) for facilitating suitable data transfer operations.

FIG. 5B depicts a timing diagram of the various signals used in the present invention as shown in FIG. 5A, but with a phase difference wherein the primary clock signal (CLK1 104) leads the secondary clock signal (CLK2 105). Reference numeral 510 refers to an exemplary phase amount by which CLK2 lags CLK1. From a normal clock state 505, the clock synchronizer controller enters a transitional phase 507 wherein appropriate skew compensation operations described in detail hereinabove take place for deleting a clock cycle (e.g., cycle 2), while data transfer operations may continue in adjusted time windows. Accordingly, the pulse widths of NDSYNC and NRSYNC signals are compressed in the compensated phase 507. After redefining the new coincident rising edges of the clock signals, the original cycle 4 becomes the new cycle 0 in [−1 State] 509 based on the new coincident rising edges.

Analogously, FIG. 5C depicts a timing diagram of the various signals of the present invention wherein the secondary clock signal (CLK2 105) leads the primary clock signal (CLK1 104). Reference numeral 514 refers to an exemplary phase amount by which CLK2 leads CLK1. From a normal clock state 505, the clock synchronizer controller enters a transitional phase 511 wherein appropriate skew compensation operations described in detail hereinabove take place for adding an extra clock cycle (e.g., cycle 2). Accordingly, the pulse widths of NDSYNC and NRSYNC signals are expanded in the compensated phase 511. Once again, upon suitably defining new coincident rising edges for the clock signals, the original cycle 1 becomes the new cycle 0 in [+1 State] 513, which re-positions the SYNC pulse.

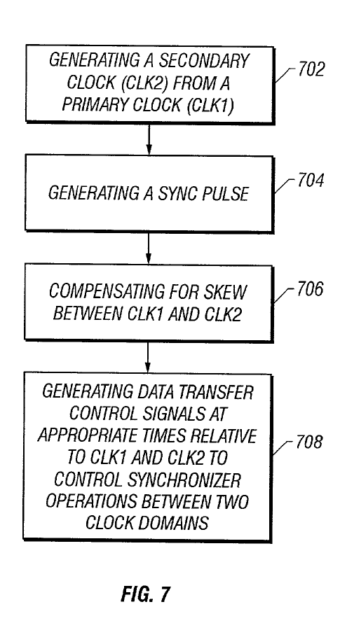

Referring now to FIG. 6A, depicted therein is an exemplary data transfer synchronizer circuit 600A operable as CLK1-TO-CLK2 synchronizer 118 for facilitating data transmission from the circuit portion 114 clocked with the primary clock signal 104 to the circuit portion 112 clocked with the secondary clock signal 105. A pair of cross-coupled NAND gates 614, 616 are operable as an asynchronous Set/Reset (SR) flip-flop (FF) 612 wherein NAND 614 is clocked by CLK2 105 and NAND 616 is clocked by CLK1 104. The CLK1-TO-CLK2 NDSYNC control signal 320, which may have been staged through appropriate registers, is provided to a D flip-flop 610 which delays the NDSYNC pulse by a clock cycle of CLK1. The output (Q) of the D flip-flop 610 is provided as input to NAND 614 of the asynchronous SR flip-flop 612. The output of NAND 614 is ANDed with inverted CLK1 by AND 608, whose output enables a latch 604 disposed on a CLK1-TO-CLK2 data path 602. The output from the latch 604 is staged through a data path D flip-flop 606 that is clocked by CLK2. The output of D flip-flop 606 may be appropriately buffered before being provided to the second circuit portion.

FIG. 6B depicts an exemplary data transfer synchronizer circuit 600B operable as CLK2-TO-CLK1 synchronizer 116 for facilitating data transmission from the circuit portion 112 clocked with the secondary clock signal 105 to the circuit portion 114 clocked with the primary clock signal 104. Similar to the data transfer synchronizer circuit 600A above, a pair of cross-coupled NAND gates 664, 666 are operable as an asynchronous Set/Reset (SR) flip-flop (FF) 662 wherein NAND 664 is clocked by CLK1 104 and NAND 666 is clocked by CLK2 105. The CLK2-TO-CLK1 NRSYNC control signal 318, which may also have been staged through appropriate registers, is provided to a D flip-flop 658 which delays the NRSYNC pulse by a clock cycle of CLK1. The output (Q) of the D flip-flop 658 is staged through another D flip-flop 660 that is clocked on the falling edge of CLK1 104. The Q output from the D flip-flop 66o is provided as input to NAND 664 of the asynchronous SR flip-flop 662. The output of NAND 664 is ANDed with CLK2 by AND 656. Inverted CLK2 105 is also provided to a latch 652 disposed on a CLK2-TO-CLK1 data path 650. The output of the latch 652 is staged through another data path latch 654 that is enabled by the output of AND 656. Once again, the output of the latch 654 may be appropriately buffered before being provided to the first circuit portion in CLK1 domain.

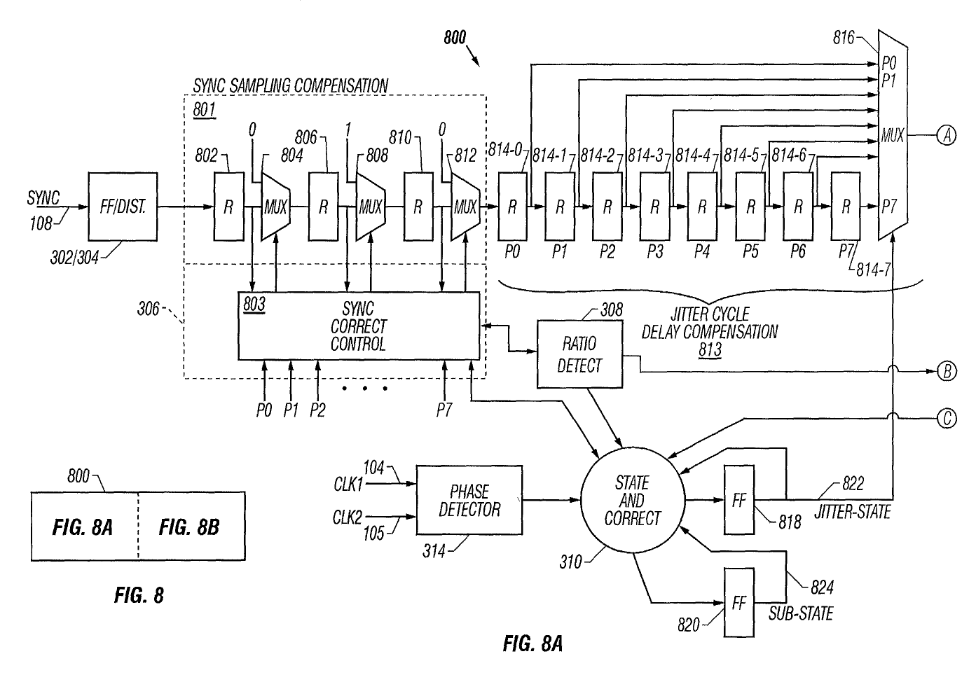

FIG. 7 is a flow chart of the various steps involved in an exemplary methodology for synchronizing data transfer operations across a clock domain boundary in accordance with the teachings of the present invention. Upon providing a system or core clock (i.e., the primary clock), a secondary clock (e.g., bus interface clock) is generated by such means as a PLL or its equivalents (step 702). A SYNC pulse signal is generated based on a predetermined temporal relationship between the two clocks (step 704). As has been explained in the foregoing, the SYNC pulse is used for coordinating the timing sequence of the data transfer operations. Movement in the SYNC pulse due to any skew between the primary and secondary clocks is compensated for by a SYNC adjust mechanism depending on the detected phase difference and accordingly expanding or compressing the clocks so as to reposition the SYNC pulse (step 706). Data transfer control signals are generated thereafter based on the adjusted SYNC pulse signal at appropriate times relative to the primary and secondary clocks to control the operation of synchronizer circuitry disposed between the two clock domains (step 708).

As has been pointed out hereinbefore, although the SYNC pulse is registered by CLK1, it is generated with respect to CLK2. Accordingly, as the skew compensation mechanism redefines the coincident rising edges of the clock signals to obtain a re-positioned SYNC pulse, its position relative to an expected time window may itself have certain skew or, jitter. Further, the SYNC pulse jitter may be of such magnitude that the pulse may be “lost” (i.e., not within the expected time window) or may appear in duplicate. Where it is lost, it needs to be regenerated and where in duplicate, the pulse duplicate condition must be corrected such that only a single SYNC pulse appears. In such scenarios, the jitter effect needs to be removed from the SYNC pulse because unlike the skew compensation mechanism in which the SYNC pulse may have to be moved back and forth due to actual phase differences between the primary and secondary clocks, the jitter effect is essentially a spurious anomaly with serious negative consequences for data transfer operations. Thus, it is necessary for the clock synchronizer circuit to nullify its effect before being propagated to the Tapline/Selection block that drives the control signals with appropriate timing relationships as described hereinabove.

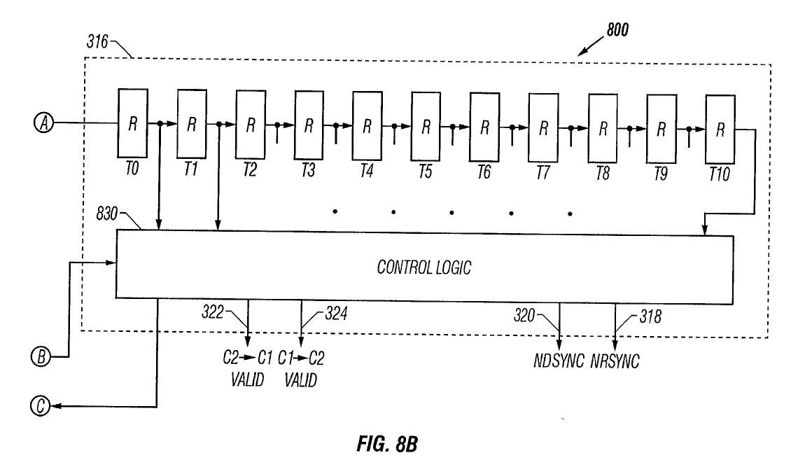

Referring now to FIGS. 8A and 8B which together form FIG. 8, depicted therein is a further exemplary embodiment of a clock synchronizer controller 800 having a SYNC compensator circuit 802 and jitter cycle delay compensation circuit 813 for providing SYNC pulse sampling and jitter compensation in accordance with the teachings of the present invention. Upon generating the SYNC pulse 108 and propagating it through appropriate flip-flop and distributor circuitry 302/304 as described above, it is provided to the SYNC compensator circuit 802. As the clock frequency ratio is known (due to the Ratio Detect block 308), cycle 0 as defined by the compensated/corrected SYNC pulse in State 0 is expected in the middle of a time window demarcated by a plurality of timing registers, e.g., registers 802, 806 and 810. When SYNC correct is sampled, it is thus expected to exhibit a “010” binary sequence. If, for instance, the SYNC correct is sampled to be all zeros (indicating a lost SYNC pulse), a binary “1” is inserted in the middle by activating a MUX 808 so as to restart the SYNC pulse in the appropriate timing window. When a duplicate pulse condition is signified by obtaining “011” or “110” sequence, the extra “1” at the ends is masked by activating logic such that only one properly timed SYNC pulse remains in the timing window. For example, when the “011” sequence is encountered, MUX 812 is activated so as to replace “1” at the right end with a “0”. Similarly, when the “110” sequence is encountered, MUX 804 is activated so as to replace “1” at the left end with a “0”.

If the SYNC pulse has jumped ahead or behind a clock cycle, binary sequences such as “100” or “001” are obtained upon sampling the SYNC correct. In such scenarios, the jitter cycle delay compensation circuit 813 is utilized in conjunction with the SYNC correct control block 803 of the SYNC correct 306 whereby the SYNC pulse is tapped after an appropriate string of delay registers such that the effect of the jumping ahead or behind of the SYNC pulse is effectively nullified. A pair of delay lines (not shown), preferably an ADD delay line and a SUBTRACT delay line, are provided as part of the SYNC correct control block 803. Upon determining where the SYNC pulse currently is, either the ADD delay line or the Subtract delay line is appropriately actuated to nullify the effects of the jumped SYNC pulse. In the exemplary embodiment depicted in FIG. 8, eight delay registers P0 through p7 (reference numerals 814-0 through 814-7) are provided. Selection of the tap points in the delay register sequence is effectuated by a MUX 816 that is controlled by a JITTER-STATE control signal 822 generated by the State and Correct block 310. As has been described in greater detail hereinabove with reference to FIG. 3, the State and Correct block 310 is operable responsive to the phase detector 314, SYNC Correct 306, and Ratio Detect block 308. The JITTER-STATE signal 822 may be held via a buffer flip-flop 818. When the JITTER-STATE variable is 0, the SYNC pulse signal is tapped after the P0 register. Similarly, for JITTER-STATE values of 1, 2, 3, and 4, the respective tap points are P1, P2, P3, and P4. In the case of JITTER-STATE values in the opposite direction, i.e., −1, −2, −3, and −4, the corresponding tap points are P4, P3, P2, and P1 because of the wraparound in the 5:4 cycle ratio.

It should be appreciated by those skilled in the art that the number of jitter cycle delay registers used depends on the number of clock ratios supported in a particular implementation. In the exemplary embodiment depicted in this FIG., up to eight cycle ratios ([N: (N−1), where N=2→8) may be supported as there are eight registers in the jitter cycle delay compensator 813.

Continuing to refer to FIG. 8A, a SUB-STATE signal 824 that is staged through a flip-flop 820 may also be generated by the State and Correct block 310 for dampening any oscillations in the detect-correct cycles of the clock synchronizer circuit 800. Since there is a finite time delay for a correction to take place after a particular state is detected, the SUB-STATE signal 824 is monitored and double-sampled such that the possibility of a particular state occurring successively in a relatively short period of time (i.e., in rapid succession) is reduced.

As shown in FIG. 8B, the compensated SYNC pulse signal from the jitter cycle delay compensator 813 is provided to the Tapline and Selection block 316 which drives a control logic block 830 operable to generate the control signals described in greater detail hereinabove. In the particular exemplary embodiment depicted in this FIG., eleven delay registers, T0 through T11, are illustrated. Outputs from each of the delay registers are provided to the control logic circuit 830 for facilitating appropriate timing relationships among the control signals generated. Further, similar to the exemplary embodiment depicted in FIG. 3, the control logic provides appropriate timing information to the State and Correct block 310.

Based upon the foregoing Detailed Description, it should be readily apparent that the present invention provides an innovative clock synchronizer controller system that allows two interfaces operating at different clock frequencies to send information back and forth at high speeds and at low latencies, even if the skew between the clocks is substantial. In fact, the loop-back clock state arrangement used in the presently preferred exemplary clock synchronizer controller implementation (wherein the number of clock states is dependent on the frequency ratio) provides the capability to tolerate virtually an infinite amount of skew by taking advantage of the circular nature of the phase difference in the clocks. In addition, the present invention advantageously provides SYNC pulse recovery (when the pulse is lost), grooming (when duplicate SYNC pulses occur) and jitter cycle delay compensation to increase the reliability of cross-domain data transfer operations.

Further, it is believed that the operation and construction of the present invention will be apparent from the foregoing Detailed Description. While the system and method shown and described have been characterized as being preferred, it should be readily understood that various changes and modifications could be made therein without departing from the scope of the present invention as set forth in the following claims.

What is claimed is:

1. A SYNC pulse compensation apparatus, comprising:
a sampling compensation circuit operable to condition a SYNC pulse signal, wherein said SYNC pulse signal is based on a predetermined temporal relationship between a first clock signal operable to clock a first circuit portion and a second clock signal operable to clock a second circuit portion; and
a jitter cycle delay compensation circuit coupled to said sampling compensation circuit, said jitter cycle delay compensation circuit operating to tap said SYNC pulse signal after a predetermined delay based on a skew difference between said first and second clock signals.

2. The SYNC pulse compensation apparatus as set forth in claim 1, wherein said sampling compensation circuit comprises a plurality of multiplexers arranged in series, each multiplexer operating to receive an input through a timing register associated therewith.

3. The SYNC pulse compensation apparatus as set forth in claim 2, wherein said multiplexers are operable to insert a logic high condition in said SYNC pulse signal when said SYNC pulse signal is sampled to contain a plurality of logic lows during a predetermined time window.

4. The SYNC pulse compensation apparatus as set forth in claim 2, wherein said plurality of multiplexers comprises three multiplexers operable to insert a [010] sequence in said SYNC pulse signal when said SYNC pulse signal is sampled to be all zeros during a predetermined time window.

5. The SYNC pulse compensation apparatus as set forth in claim 1, wherein said jitter cycle delay compensation circuit comprises:
a series of delay registers, each operating to delay said SYNC pulse signal by a predetermined amount of time; and
a multiplexer operable to select a delayed SYNC pulse output generated from said series of delay registers.

6. The SYNC pulse compensation apparatus as set forth in claim 5, wherein said series of delay registers comprises eight registers.

7. The SYNC pulse compensation apparatus as set forth in claim 5, wherein said multiplexer is actuated by a JITTER-STATE control signal generated by a state/correct block responsive to said skew difference between said first and second clock signals.

8. The SYNC pulse compensation apparatus as set forth in claim 7, wherein said state/correct block is coupled to a phase detector operating to detect said skew difference between said first and second clock signals.

9. The SYNC pulse compensation apparatus as set forth in claim 7, wherein said JITTER-STATE control signal is stored in a flip-flop.

10. A SYNC pulse compensation method, comprising the steps:
sampling a SYNC pulse signal generated based on a predetermined temporal relationship between a first clock signal operable to clock a first circuit portion and a second clock signal operable to clock a second circuit portion; and
if said SYNC pulse signal is sampled to contain a plurality of a logic lows during a predetermined time period, inserting a logic high condition at a select point in time.

11. The SYNC pulse compensation method as set forth in claim 10, wherein said second clock signal is generated by a phase-locked loop (PLL) based on said first clock signal.

12. The SYNC pulse compensation method as set forth in claim 10, wherein said SYNC pulse signal is generated when a rising edge in said first clock signal coincides with a rising edge in said second clock signal.

13. The SYNC pulse compensation method as set forth in claim 12, further comprising the step:
if said SYNC pulse signal is sampled to indicate a duplicate logic high condition during a predetermined time period, masking said duplicate logic high condition.

14. A SYNC pulse compensation method, comprising the steps:
sampling a SYNC pulse signal generated based on a predetermined temporal relationship between a first clock signal operable to clock a first circuit portion and a second clock signal operable to clock a second circuit portion;
determining a clock state indicative of a phase difference between said first and second clock signals;
re-positioning said SYNC pulse signal based on said clock state; and
if said SYNC pulse signal is out-of-phase by a predetermined amount with respect to said first clock signal, delaying said SYNC pulse signal based on said clock state.

15. The SYNC pulse compensation method as set forth in claim 14, wherein said SYNC pulse signal is re-positioned by adding at least an extra clock cycle when said clock state indicates that said first clock signal lags with respect to said second clock signal by a predetermined amount.

16. The SYNC pulse compensation method as set forth in claim 14, wherein said SYNC pulse signal is re-positioned by deleting at least an extra clock cycle when said clock state indicates that said second clock signal lags with respect to said first clock signal by a predetermined amount.

17. The SYNC pulse compensation method as set forth in claim 14, wherein said SYNC pulse signal is delayed by propagating said SYNC pulse signal through a series of delay registers operable to be selected by a multiplexer in response to a JITTER-STATE control signal corresponding to said clock state.

18. The SYNC pulse compensation method as set forth in claim 17, wherein said JITTER-STATE control signal is stored in at least one flip-flop.

19. The SYNC pulse compensation method as set forth in claim 14, wherein said first and second clock signals comprise a core clock and a bus clock, respectively, in a computer system.
